(19) United States
(12) Patent Application Publication
(10) Pub. No.: US 2026/0121940 A1
(43) Pub. Date: Apr. 30, 2026

(54) DISTRIBUTED ARTIFICIAL INTELLIGENCE-BASED SYSTEM MANAGEMENT

(71) Applicant: Dell Products L.P., Round Rock, TX (US)

(72) Inventor: DHARMESH M. PATEL, Round Rock, TX (US)

(21) Appl. No.: 18/932,902

(22) Filed: Oct. 31, 2024

(51) Int. Cl. H04L 41/16; H04L 41/12; H04L 67/10

(52) U.S. Cl. CPC H04L 41/16; H04L 41/12; H04L 67/10

(57) ABSTRACT

Methods, systems, and devices are provided for managing operation of a distributed system. To do so may be based on a request to update the operation to facilitate provisioning of artificial intelligence (AI) based computer implemented services. Based on the request, an AI architecture map may be obtained that defines logical components to provide the services. A plurality of likely use maps may be obtained that indicate how the services are likely to be used. A goal architecture may be obtained based on the AI architecture map and the plurality of likely use maps. Based on at least the goal architecture, a plurality of hardware components and a plurality of software components may be selected. These selections may be deployed to the distributed system, based on the goal architecture, to obtain an updated distributed system. The services may thereby be provided using the updated distributed system.

### FIELD

Embodiments disclosed herein relate generally to management of data processing systems. More particularly, embodiments disclosed herein relate to systems and methods for management of distributed artificial intelligence-based systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating systems in accordance with an embodiment.

FIGS. 2A-2E show data flow diagrams illustrating data and processes for operating a system in accordance with an embodiment.

FIG. 3 shows a flow diagram illustrating a method for managing operation of a system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems in a distributed environment that may provide, at least in part, computer implemented services. The computer implemented services may be provided to any type and/or number of other devices and/or users of the data processing systems. Furthermore, the provided computer implemented services may be of any quantity and/or type of such services.

To provide the computer implemented services, data processing systems may include hardware components and/or software components. For example, operation of these components may facilitate various functionalities of a data processing system, thereby causing the data processing system to provide the computer implemented services. Additionally, such operation of the components may depend on how such components interact with one another and/or data each component may be adapted to use, for example, as specified by a system architecture in which these components may be a part.

For example, by changing how the components interact with one another, thereby changing the system architecture, the operation may be updated, and thus, may facilitate the various functionalities in a different (e.g., updated) manner and/or facilitate new functionalities all together than those prior to the update. Consequently, if the components are not configured to be in a correct architecture, then the services may not be provided as expected or desired by a consumer of such services.

To increase a likelihood of providing computer implemented services as expected and/or desired by a consumer of such services, a distributed system may leverage an architectural regulation framework.

This architectural regulation framework may include (i) performing system management actions to select an artificial intelligence (AI) architecture and correspondingly supportive hardware based on distribution requirements of a client, and (ii) deploying, based on the supportive hardware, a supplemental system portion to implement the selected AI architecture for the client.

In an embodiment, a method for managing operation of a distributed system is provided.

The method may include, based on a request to update the operation of the distributed system to facilitate provisioning of artificial intelligence based computer implemented services: obtaining, based on the request, an artificial intelligence architecture map that defines logical components to provide the artificial intelligence based computer implemented services; obtaining a plurality of likely use maps that indicate how the artificial intelligence based computer implemented services are likely to be used; obtaining, based on the artificial intelligence architecture map and the plurality of likely use maps, a goal architecture; selecting, based on at least the goal architecture, a plurality of hardware components and a plurality of software components; deploying, based on the goal architecture, the plurality of hardware components and the plurality of software components to the distributed system to obtain an updated distributed system; and providing the artificial intelligence based computer implemented services using the updated distributed system.

The plurality of likely use maps may include a data source locations map that indicates first geographic locations of data sources of the distributed system that are likely to be used to provide the artificial intelligence-based computer implemented services.

The plurality of likely use maps may further include a use locations map that indicates second geographic locations of likely uses of the artificial intelligence-based computer implemented services.

The plurality of likely use maps may further include a workload weightings map that indicates relative levels of importance of different types of workloads performed to provide the artificial intelligence-based computer implemented services.

The logical components may include an inference model training module; an inference generating module; an inference model updating module; a training data processing module; and an inference model distillation module.

The goal architecture may indicate a first plurality of hardware components and a first plurality of software components usable to implement an artificial intelligence system based on the artificial intelligence architecture map.

The distributed system may include a portion of existing hardware components that are usable as a first portion of the first plurality of hardware components, and the plurality of hardware components may be usable as a second portion of the first plurality of hardware components.

The obtaining of the goal architecture may include performing an optimization process using the plurality of likely use maps and the request to select the first plurality of hardware components and the first plurality of software components.

The optimization process may be a global optimization process, and constraints used in the global optimization process may be based on the request and at least one of the plurality of likely use maps.

At least one of the constraints may be a maximum latency for the artificial intelligence-based computer implemented services.

At least one of the constraints may be a maximum cost for implementing an artificial intelligence system to provide the artificial intelligence-based computer implemented services.

The locations for the first plurality of hardware components and the first plurality of software components may also be selected during the optimization process.

In an embodiment, a non-transitory media is provided. The non-transitory media may include instructions that when executed by a processor cause, at least in part, the computer-implemented method to be performed.

In an embodiment, a data processing system is provided. The data processing system may include the non-transitory media and a processor and may, at least in part, perform the method when the computer instructions are executed by the processor.

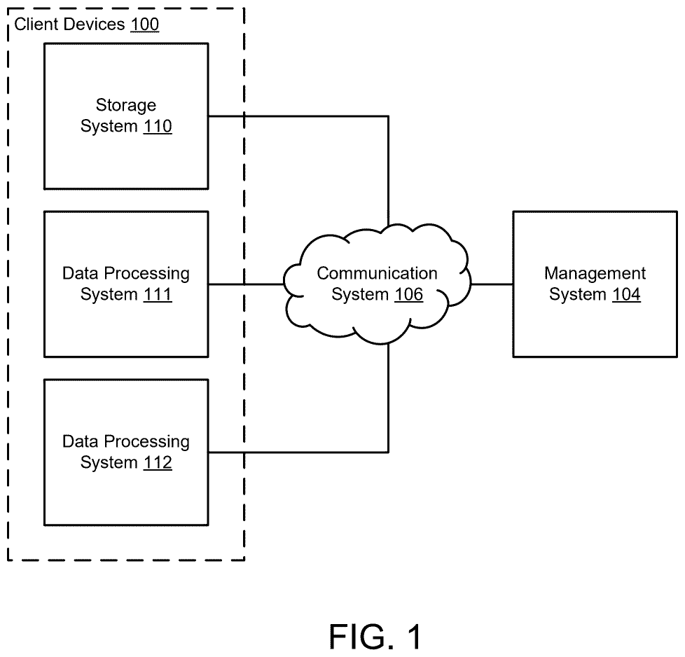

Turning to FIG. 1, a block diagram illustrating a system in accordance with an embodiment is shown. The system shown in FIG. 1 may be a distributed system that provides computer implemented services.

These services may include any type and/or quantity of services. These services may include, for example, database services, data processing services, electronic communication services, and/or any other services that may be provided by one or more computing devices.

Other types of services may be provided by the system shown in FIG. 1 without departing from embodiments disclosed herein.

To provide these services, the system may include any number of data processing systems (e.g., computing devices) such as any of client devices 100. These data processing systems may include any quantity of software components and/or hardware components. These components may include, for example, processors, memory modules, storage devices, communications devices, power components, software applications, device drivers, and/or any other type of component whose respective operation may facilitate various functionalities of the data processing systems. By facilitating such functionalities of the data processing systems, the respective operation of such components may cause the services to be provided.

However, this operation of the hardware components and/or the software components may depend on an architecture of the components used during such operation. For example, the architecture of the components may determine which of the components may contribute to the operation, and how the contributing components may be configured to (i) interact with one another during the operation, and/or (ii) utilize various types and/or quantities of data. Consequently, if the components are not configured to be in a correct architecture, then the services may not be provided as expected or desired by a consumer of such services (e.g., correct services may not be provided as expected and/or desired by a service providing entity such as management system 104, discussed further below).

To increase a likelihood of providing computer implemented services as expected and/or desired by a consumer of such services (e.g., a client of management system 104 desiring the services), a distributed system may include components such as those illustrated and discussed with regard to FIG. 1, below.

In general, embodiments disclosed herein relate to systems, devices, and methods for managing operation of a distributed system that may provide computer implemented services. To do so, an architectural regulation framework may be leveraged.

This architectural regulation framework may include (i) performing system management actions to select an artificial intelligence (AI) architecture and correspondingly supportive hardware based on distribution requirements for the distributed system, for example, of a client, and (ii) deploying, based on the supportive hardware, a supplemental system portion to implement the selected AI architecture for the client. Once deployed, the distributed system may have an increased likelihood (e.g., the increased likelihood), of providing the computer implemented services as expected and/or desired by the client.

For example, this increased likelihood may be due to performance of system management actions being based on system distribution requirements for the distributed system that are determined by the client. These requirements may be identified by obtaining a goal description and other client information from the client and for the AI model.

Using these requirements, an AI architecture map and a plurality of likely use maps may be obtained. The AI architecture map may include functional (e.g., logical) components that if build, may meet the client's expectations and/or desires. To facilitate the building of such components, the plurality of likely use maps may be leveraged to consider various types of information included in such maps. Such information may be, as mentioned above for example, the distribution requirements.

Once the maps and the AI architecture map are obtained, they may be ingested into an optimization process along with some constraints that may be obtained from the goal description. These constraints may be used to obtain an optimized (e.g., idealized) architecture for the distributed system referred to as a goal architecture. From the goal architecture we may select a supplemental hardware system for supporting the goal architecture within the distributed system to increase the likelihood of the distributed system providing the services as expected/desired. However, before the providing of the services is enabled, the selected supplemental hardware system may be deployed to the distributed system of the client. Once deployed, the distributed system may become operational, thereby resulting in the providing of the services.

To provide the above noted functionality, the system of FIG. 1 may include client devices 100, management system 104, and communication system 106. Each of these is discussed below.

Client devices 100 may include any number of data processing systems, storage systems, and/or other device systems, such as storage system 110, data processing system 111, and data processing system 112. Any of these systems may (i) be included in, for example, a (larger) distributed system, (ii) have their respective functionalities and/or communications with one another managed by a management system to facilitate operation of the distributed system, (iii) be located at a unique location and/or located at a same location as another of the any number systems, and/or (iv) provide, for example, artificial intelligence based-computer implemented services.

To provide its functionality, for example, storage system 110 may be implemented by any number of storage devices and/or memory modules. Assume, for example, that storage system 110 is at a first location, say, in Denver, Colorado. To provide their functionalities, for example, data processing systems 111-112 may be implemented by two computing devices. Further assume, for example, that data processing system 111 is at a second location, say, in Houston, Texas, and that data processing system 112 is at a third location such as Austin, Texas. Based on the assumptions, if these systems are all to communicate with one another via operable connections over great distance, then these systems may require an artificial intelligence model to be supported by their distributed systems. Such an artificial intelligence model may be managed based on facilitating a goal architecture and identifying supportive hardware and an overall optimization of their distributed system.

Management system 104 may (i) manage other systems such as any of client devices 100, (ii) provide computer implemented services, (iii) communicate with the various systems, devices, and/or entities within the system of FIG. 1, and/or (iv) cooperate with the various systems, devices, and/or entities to facilitate the previously mentioned architectural regulation framework to manage the distributed system.

To provide its functionality, management system 104 may include any number of devices (e.g., data processing systems) collaboratively working to facilitate the architectural regulation framework. As part of the architectural regulation framework, management system 104 may, for example, (i) obtain the goal description and the other client information, (ii) obtain the AI architecture map and the plurality of likely use maps, (iii) perform an optimization process to obtain the goal architecture based on constraints, the AI architecture map, and the plurality of likely use maps, (iv) select a supplemental system portion, and/or (iv) deploy the supplemental system portion. Once deployed to various locations, the supplemental system may enable the distributed system to provide the prosses as expected and/or desired by the client.

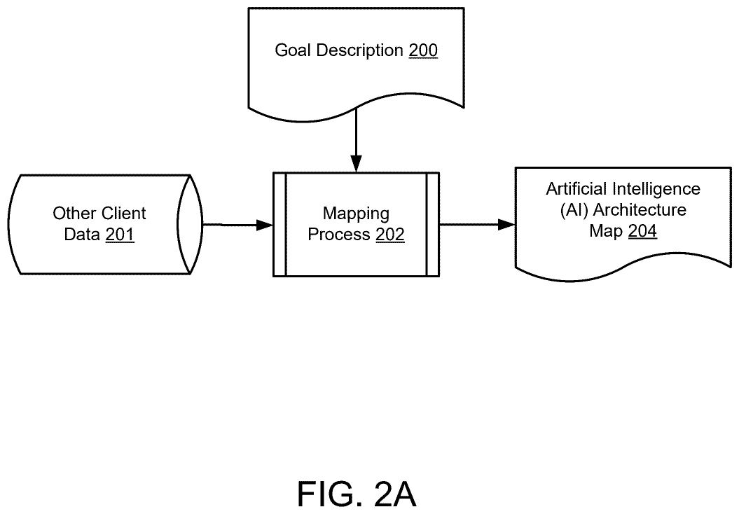

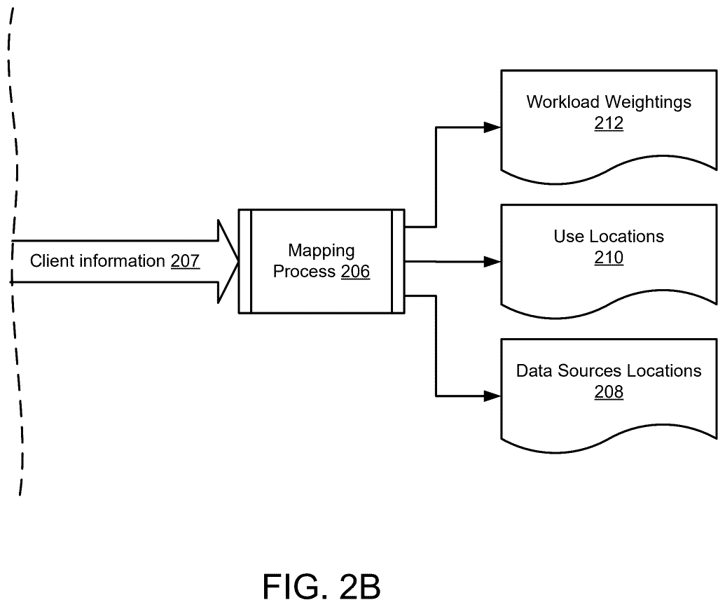

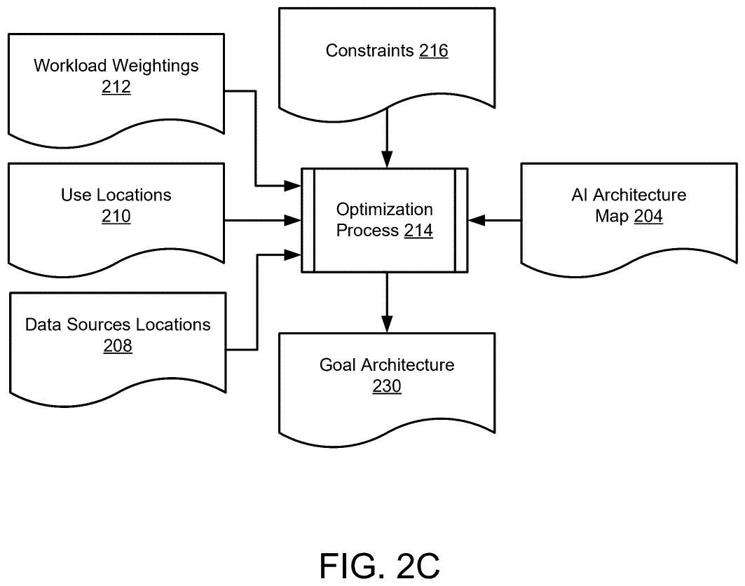

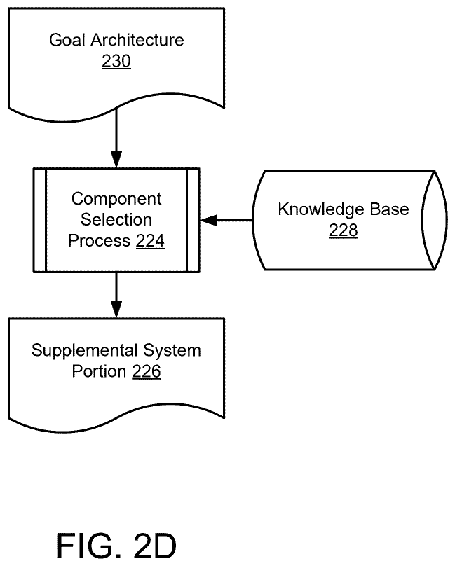

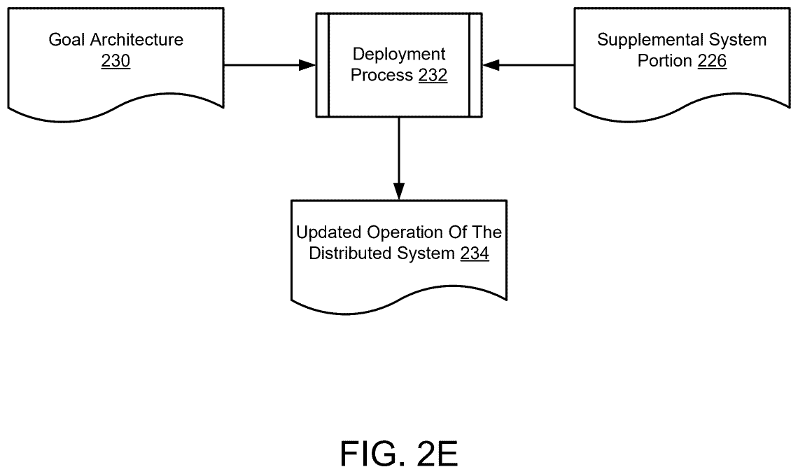

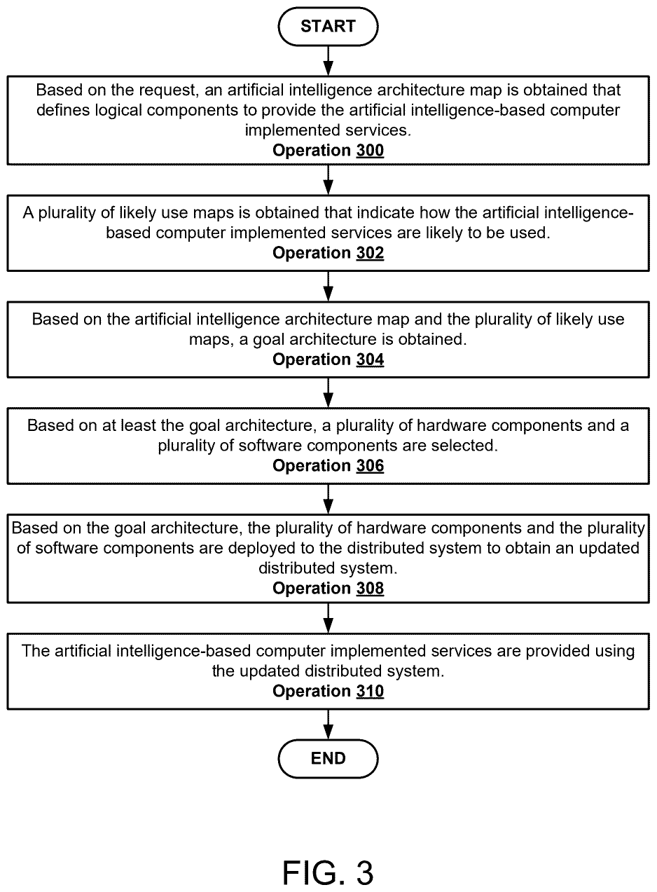

For additional information regarding the architectural regulation framework, refer to FIGS. 2A-3.

When providing their functionality, client devices 100, and/or management system 104 may perform all, or a portion, of the method shown in FIG. 3.

Any devices (and/or components thereof) included in the system of FIG. 1 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system.

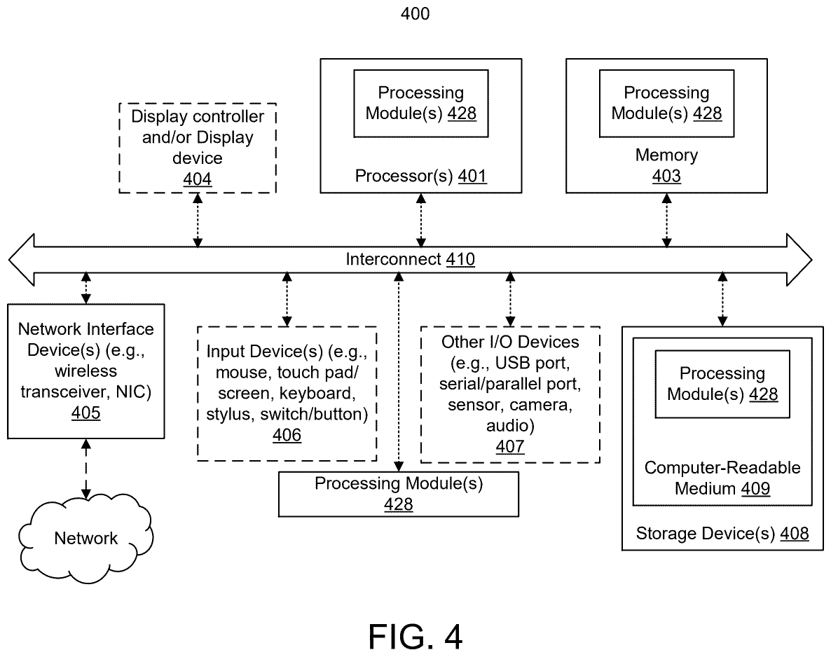

For additional details regarding computing devices, refer to FIG. 4.

Any of the components illustrated in FIG. 1 may be operably connected to each other (and/or components not illustrated) with a communication system (e.g., 106) utilized by client devices 100, and/or management system 104 to, for example, cooperate with one another to facilitate the architectural regulation framework.

In an embodiment, this communication system may include one or more networks that facilitate communication between any number of components. The networks may include wired networks and/or wireless networks (e.g., and/or the Internet). The networks may operate in accordance with any number and types of communication protocols (e.g., such as the internet protocol).

Thus, by facilitating such a framework as the architectural regulation framework, there may be an increased likelihood of providing computer implemented services as expected and/or desired by the client by basing management of the system on the system's distribution throughout an environment.

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2E. These data flow diagrams may illustrate how data may be obtained and used within the system of FIG. 1.

In the data flow diagrams, such as in FIGS. 2A-2E, flows of data and processing of data are illustrated using different sets of shapes. In the context of these data flow diagrams, a first set of shapes (e.g., 200, 204, etc.) is used to represent data structures, a second set of shapes (e.g., 202, 206, etc.) is used to represent processes performed using and/or that generate data, and a third set of shapes (e.g., 201, etc.) is used to represent large scale data structures such as databases (e.g., that include some type of schema and/or a large repository of (e.g., proprietary) data).

Turning to FIG. 2A, a first data flow diagram in accordance with an embodiment is shown. The first data flow diagram may illustrate data used in and data processing performed in identifying functional (logical) components on which the providing of the services as expected may depend.

To identify the functional components, mapping process 202 may be performed. During mapping process 202, (i) goal description 200 may be ingested and (ii) other client data 201 may be ingested, each being discussed below, to obtain artificial intelligence (AI) architecture Map 204.

Goal description 200 may be obtained based on, for example, a request to update operation of the distributed system to facilitate provisioning of artificial intelligence-based computer implemented services. For example, goal description 200 may be provided directly from the client discussed with regard to FIG. 1 via a prompt shown to the client using a user interface (UI). This UI, for example, may be managed, at least in part, by management system 104. Additionally, this UI may be hosted on any of client devices 100, and other client data 201 may be accessible via, at least in part, storage system 110, storage devices of management system 104, and/or any other storage devices operably connected to management system 104.

Other client data 201 may be obtained, for example, from a database repository that stores, at least in part, information regarding various clients, and therefore, the client. This information may include information such as historical data of the client and/or data that may otherwise be used to determine what the client's expectations and/or desires may be with regard to the client's business and/or the distributed system requested for update.

For example, this data may include prior models obtained for the client, any other associated processes that may be facilitated between the client and management system 104, communications that occur from and/or between various devices within the distributed system of the client, and/or any other data that may be otherwise relevant to the client.

By ingesting goal description 200 and other client data 201, AI architecture map 204 may be obtained. AI architecture map 204 may include functional (logical) components that have functionalities adapted for meeting the client's business goals. These functional (logical) components may include, for example, an inference model training module, an inference generating module, an inference model updating module, a training data processing module, and/or an inference model distillation module. These functional (logical) components may be built to meet the client's business goal, the goal being indicated by goal description 200. To build the functional (logical) components, information specifying how to build them optimally may be obtained.

Turning to FIG. 2B, a second data flow diagram in accordance with an embodiment is shown. The second data flow diagram may illustrate data used in and data processing performed in, for example, analysis of (e.g., additional) client information regarding the distribution of their respective distributed system. For example, this analysis may result in a reordering or restructuring of the information for use during other portions of the architectural regulation framework.

To do so, mapping process 206 may be performed. During mapping process 206, client information 207 may be ingested to obtain a plurality of likely use maps.

Client information 207 may be obtained similar to goal description 200, and/or other processes involving a procurement of information regarding the client and the client's business needs either provided by the client, a recorded history associated with the client, and/or other avenues for procuring such data. Client information 207 may include, for example, a list including every device included in the distributed system, how each device is integrated with the distributed system, locations of each device within the distributed system, types and/or quantities a of each device in distributed system, functionality of each device in the distributed system, and/or any other data that may otherwise indicate an infrastructure of the distributed system, then distributed system's purpose, and/or the distributed system's operation.

The plurality of likely use maps may be a reformatted, organized, and/or otherwise processed version of the data included in client information 207 such that the data may be better utilized in subsequent processes. For example, the plurality of likely use maps may include (i) workload weightings 212, (ii) use locations 210, and (iii) data source locations 208, each of these being discussed below.

Workload weightings 212 may be a workload weightings map that indicates relative levels of importance of different types of workloads performed to provide the artificial intelligence-based computer implemented services.

Use locations 210 may be a use locations map that indicates second geographic locations of likely uses of the artificial intelligence-based computer implemented services.

Data source locations may be a data source locations map that indicates first geographic locations of data sources of the distributed system that are likely to be used to provide the artificial intelligence-based computer implemented services.

Thus, the plurality of likely use maps may be obtained. For additional information regarding the plurality of likely use maps, refer to FIG. 3, discussed further below.

Turning to FIG. 2C, a third data flow diagram in accordance with an embodiment is shown. The third data flow diagram may illustrate data used in and data processing performed in an optimization process for optimizing operation of the distributed system.

To do so, optimization process 214 may be performed. During optimization process 214, (i) AI architecture map 204 may be ingested, (ii) workload weightings 212 may be ingested, (iii) use locations 210 may be ingested, (iv) data source locations 208 may be ingested, and/or (v) constraints 216, discussed below, may be ingested.

Constraints 216 may be obtained, for example, based on the request and/or subsequent information indicated by goal description 200 and/or at least one of the plurality of likely use maps. The constraints may specify (e.g., quantitate) a quality desired for the distributed system. For example, at least one of the constraints may be a maximum latency for the artificial intelligence-based computer implemented services, a maximum cost for implementing an artificial intelligence system to provide the artificial intelligence-based computer implemented services, and/or other attributes/qualities that indicate how the distributed system operates. For example, when the distributed system operates within the constraints, such operation may be optimized to provide the previously mentioned services as expected and/or desired by the client.

For additional information regarding the constraints, refer to FIG. 3 discussed further below.

By performing optimization process 214, details (e.g., a plan, a blueprint, a guide, etc.) to build the functional (logical) components may be obtained. These details may be included in goal architecture 230, as shown in FIG. 2C. For example, goal architecture 230 may indicate hardware components and/or software components for facilitating the optimized operation of the distributed system by including and enabling the functional (logical) components to contribute respective functionalities to the distributed system's operation.

Turning to FIG. 2D, a fourth data flow diagram in accordance with an embodiment is shown. The fourth data flow diagram may illustrate data used in and data processing performed in a component selection process for identifying and providing an infrastructure to the distributed system that is capable to facilitate the optimized operation.

To do so, component selection process 224 may be performed. During component selection process 224, (i) goal architecture 230 may be ingested, and (ii) knowledge base 228 may be ingested, discussed below.

Knowledge base 228 may be a repository that stores information regarding the distributed system such as each component location, type of component, quantity of component, component configuration, etc. for all the hardware components included in, and/or all the software components included in, the distributed system. Therefore, by ingested knowledge base 228, this stored information may be parsed, processed, and or otherwise analyzed and/or identified as discussed below.

Due to goal architecture 230 indicating how to build the functional (logical) components of the AI architecture map (e.g., by indicating what hardware components and software components may be capable of facilitating such functional components), component selection process 224 may determine what needs to be supplemented to the distributed system. To do so, performing component selection process 224 may include (i) identifying existing hardware (and/or software) of the distributed system that is also included in the goal architecture, these included existing hardware of the goal architecture being a first portion of the goal architecture, (ii) identifying a second portion of the goal architecture that does not include any of the existing hardware, (iii) selecting the second portion of the goal architecture to supplement the distributed system. This second portion may therefore be the plurality of hardware components and the plurality of software components, identified and therefore depicted as supplemental system portion 226, as shown in FIG. 2D. Thus, supplemental system portion 226 may be integrated with the distributed system to provide the infrastructure to the distributed system that is capable of facilitating the optimized operation, discussed further below.

Turning to FIG. 2E, a fifth data flow diagram in accordance with an embodiment is shown. The fifth data flow diagram may illustrate data used in and data processing performed in a deployment to enable the optimized operation.

To do so, deployment 232 may be performed. During deployment 232, (i) goal architecture 230 may be ingested, and (ii) supplemental system portion 226 may be ingested. In doing so, the components included in supplemental system portion 226 may be integrated with the existing hardware of the distributed system as indicated and/or specified by goal architecture 230. For example, goal architecture 230 may specify locations to which each hardware components and/or software components of supplemental system portion 226 may be deployed to and operably connected to some proximal portion of the existing hardware and/or otherwise integrated with the distributed system (e.g., operably connected to other devices included in the distributed system).

By facilitating this integration with existing hardware of the distributed system, the operation of the distributed system may be updated to obtain updated operation of the distributed system 234 and/or an otherwise updated distributed system. Thus, updated operation of the distributed system 234 may be the optimized operation, enabling the providing of the computer implemented services as expected and/or desired by the client.

Therefore, by facilitating the architectural regulation framework, as discussed in FIGS. 2A-2E, managed (distributed) systems may have an increased likelihood of providing computer implemented services to clients as expected by the clients.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

For additional information and/or examples regarding the architectural regulation framework, refer to FIG. 3 further below.

Thus, as discussed with regard to FIGS. 2A-2E, an architectural regulation framework may be facilitated by any number of devices such as any of client devices 100 and/or management system 104 cooperating with one another as part of, for example, the distributed system shown and discussed with regard to FIG. 1.

While illustrated in FIGS. 2A-2E with a limited number of specific components, a (distributed) system may include additional, fewer, and/or different components without departing from embodiments disclosed herein.

As discussed above, the components of FIGS. 2A-2E may facilitate and/or perform various functionalities to facilitate the architectural regulation framework. FIG. 3 illustrates a method that may be facilitated and/or performed by the components of FIGS. 1-2E.

In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing operation of a system in accordance with an embodiment is shown. The method may be performed, for example, by a management system (e.g., 104), and/or any other entity. Additionally, this method may be based on, for example, a request to update operation of a distributed system to facilitate provisioning of artificial intelligence-based computer implemented services.

At operation 300, based on the request, an artificial intelligence architecture map is obtained that defines logical components to provide the artificial intelligence-based computer implemented services. The artificial intelligence (AI) architecture map may be obtained by performing a first mapping process. This mapping process may depend on a goal description as well as other client data. By having such data that is associated with the client, a business goal associated with the client may be identified as well as any number of functional (logical) components.

The any number of functional (logical) components may include, for example, an inference model training module, an inference generating module, an inference model updating module, a training data processing module, and an inference model distillation module. Such components may be built to meet the client's business goals (e.g., to provide the artificial intelligence-based computer implemented services). However, to build these functional (logical) components, a correct architecture and hardware system may require identification and selection, as discussed further below.

At operation 302, a plurality of likely use maps is obtained that indicate how the artificial intelligence-based computer implemented services are likely to be used. The plurality may be obtained by identifying and analyzing information that may be, for example, parsed from the other client data and/or the goal description. Such information may indicate physical locations of various hardware throughout the distributed system as well as types of the hardware, quantity of each type, and relative importance of respective hardware and/or services.

For example, the plurality of likely use maps may be obtained via a second mapping process as discussed previously with regard to FIG. 2B. Based on such a process, the other client information, for example, may be used to obtain (i) a data source locations map that indicates first geographic locations of data sources of the distributed system that are likely to be used to provide the artificial intelligence-based computer implemented services, (ii) a use locations map that indicates second geographic locations of likely uses of the artificial intelligence-based computer implemented services, and (iii) a workload weightings map that indicates relative levels of importance of different types of workloads performed to provide the artificial intelligence-based computer implemented services. Thus, the plurality of likely use maps may be obtained.

At operation 304, based on the artificial intelligence architecture map and the plurality of likely use maps, a goal architecture is obtained. The goal architecture may be obtained by performing an optimization process. For example, such a process may be implemented by a global optimization process. Additionally, along with the AI architecture map and the plurality of likely use maps, constraints may be obtained and used during the optimization process. These constraints may be obtained based on or concurrently with the obtaining of the goal description, the other client information, at least one of the plurality of likely use maps, and/or otherwise based on the request.

For example, at least one of the constraints may be a maximum latency for the artificial intelligence-based computer implemented services, a maximum cost for implementing an artificial intelligence system to provide the artificial intelligence-based computer implemented services, and/or other attributes that indicate how the distributed system operates.

In the case of the maximum latency, for example, the constraint may be decreasing latency of the distributed system such that speed in which communications and/or other processes facilitated within the confines of the distributed system are increased. For example, the increasing of the speed would be an attempt to facilitate a possible maximum (e.g., the maximum being dependent on the goal architecture and supporting hardware, discussed further below) optimal speed. Therefore, the more likely that a device in the distributed system is to receive a communication from another device in the distributed system instantaneously, the more efficiently optimized and more likely it may be to provide the previously mentioned services as expected and/or desired by the client.

Consequently, by using at least one of the plurality of likely use maps, the AI architecture map, and the constraints, the optimization process may result in obtaining the goal architecture. Thus, goal architecture may include information specifying how to build the functional (logical) components, that when built and integrated with the distributed system, are likely to enable the distributed system to, for example, meet the client's business needs. For example, the goal architecture may indicate a first plurality of hardware components and a first plurality of software components usable to implement an artificial intelligence system based on the AI architecture map. The goal architecture may further indicate locations at which these components may be deployed.

At operation 306, based on at least the goal architecture, a plurality of hardware components and a plurality of software components are selected. Such components may be selected by (i) identifying existing hardware of the distributed system that is included in a first portion of the goal architecture, (ii) identifying a second portion of the goal architecture that is not included in the existing hardware, (iii) selecting the second portion of the goal architecture. This second portion may therefore be the plurality of hardware components and the plurality of software components. For example, this second portion may be the supplemental system portion as discussed with regard to FIG. 2D.

In other words, for example, the distributed system may include a portion of existing hardware components that are usable as a first portion of the first plurality of hardware components, and the plurality of hardware components are usable as a second portion of the first plurality of hardware components. Thus, the plurality of hardware components and the plurality of software components may be selected.

At operation 308, based on the goal architecture, the plurality of hardware components and the plurality of software components are deployed to the distributed system to obtain an updated distributed system. Such components may be deployed by supplementing the existing hardware of the distributed system with that which was selected (e.g., the supplemental system portion may be integrated with the distributed system). For example, the indicated locations of the goal architecture that are mentioned previously above may determine how the supplemental system portion may be integrated. Therefore, the plurality of hardware components and the plurality of software components may be deployed to the indicated locations, and thus, the distributed system may be updated to obtain the updated distributed system, thereby enabling, for example, the functional (logical) components to be built.

At operation 310, the artificial intelligence-based computer implemented services are provided using the updated distributed system. These services may be provided by the enabled updated operation of the updated distributed system. Such updated operation may be facilitated by functionality of (i) the existing hardware, (ii) the plurality of hardware components, (iii) the plurality of software components, (iv) the build functional (logical) components, and (v) any other information indicated (and/or specified) by the goal architecture.

The method may end following operation 310.

Thus, using the method illustrated in FIG. 3, embodiments disclosed herein may manage systems to increase the likelihood of providing the computer implemented services as expected and/or desired by the client.

Any of the processes and/or components illustrated in and/or discussed with regard to FIGS. 1-3 may be implemented with and/or used in conjunction with one or more computing devices.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing operation of a distributed system, the method comprising:
based on a request to update the operation of the distributed system to facilitate provisioning of artificial intelligence-based computer implemented services:
obtaining, based on the request, an artificial intelligence architecture map that defines logical components to provide the artificial intelligence-based computer implemented services;
obtaining a plurality of likely use maps that indicate how the artificial intelligence-based computer implemented services are likely to be used;
obtaining, based on the artificial intelligence architecture map and the plurality of likely use maps, a goal architecture;
selecting, based on at least the goal architecture, a plurality of hardware components and a plurality of software components;
deploying, based on the goal architecture, the plurality of hardware components and the plurality of software components to the distributed system to obtain an updated distributed system; and
providing the artificial intelligence-based computer implemented services using the updated distributed system,
wherein the plurality of likely use maps comprises a data source locations map that indicates first geographic locations of storage devices of the distributed system that are likely to be used to provide the artificial intelligence-based computer implemented services.

2. (canceled)

3. The method of claim 1, wherein the plurality of likely use maps further comprises a use locations map that indicates second geographic locations of likely data processing systems that will use the artificial intelligence-based computer implemented services.

4. The method of claim 3, wherein the plurality of likely use maps further comprises a workload weightings map that indicates relative levels of importance of different types of workloads performed to provide the artificial intelligence-based computer implemented services.

5. The method of claim 1, wherein the logical components comprise:
an inference model training module;
an inference generating module;
an inference model updating module;
a training data processing module; and
an inference model distillation module.

6. The method of claim 1, wherein the goal architecture indicates a first plurality of hardware components and a first plurality of software components usable to implement an artificial intelligence system based on the artificial intelligence architecture map.

7. The method of claim 6,
wherein the distributed system comprises a portion of existing hardware components that are usable as a first portion of the first plurality of hardware components, and the plurality of hardware components selected based on at least the goal architecture are usable as a second portion of the first plurality of hardware components,
wherein the second portion of the first plurality of hardware components are not existing components of the distributed system, and
wherein the deploying of the plurality of hardware components selected based on at least the goal architecture includes physically integrating the second portion of the first plurality of hardware components into the distributed system to form the updated distributed system.

8. The method of claim 6, wherein obtaining the goal architecture comprises:
performing an optimization process using the plurality of likely use maps and the request to select the first plurality of hardware components and the first plurality of software components.

9. The method of claim 8, wherein the optimization process is a global optimization process, and constraints used in the global optimization process are based on the request and at least one of the plurality of likely use maps.

10. The method of claim 9, wherein at least one of the constraints is a maximum latency for the artificial intelligence-based computer implemented services.

11. The method of claim 9, wherein at least one of the constraints is a maximum cost for implementing the artificial intelligence system to provide the artificial intelligence-based computer implemented services.

12. The method of claim 8, wherein locations for the first plurality of hardware components and the first plurality of software components are also selected during the optimization process.

13. A non-transitory machine-readable medium having instructions stored therein, which when executed by a processor, cause the processor to perform operations for managing operation of a distributed system, the operations comprising:
based on a request to update the operation of the distributed system to facilitate provisioning of artificial intelligence-based computer implemented services:
obtaining, based on the request, an artificial intelligence architecture map that defines logical components to provide the artificial intelligence-based computer implemented services;
obtaining a plurality of likely use maps that indicate how the artificial intelligence-based computer implemented services are likely to be used;
obtaining, based on the artificial intelligence architecture map and the plurality of likely use maps, a goal architecture;
selecting, based on at least the goal architecture, a plurality of hardware components and a plurality of software components;
deploying, based on the goal architecture, the plurality of hardware components and the plurality of software components to the distributed system to obtain an updated distributed system; and
providing the artificial intelligence-based computer implemented services using the updated distributed system,
wherein the plurality of likely use maps comprises a data source locations map that indicates first geographic locations of storage devices of the distributed system that are likely to be used to provide the artificial intelligence-based computer implemented services.

14. The non-transitory machine-readable medium of claim 13, wherein the logical components comprise:
an inference model training module;
an inference generating module;
an inference model updating module;
a training data processing module; and
an inference model distillation module.

15. The non-transitory machine-readable medium of claim 13, wherein the goal architecture indicates a first plurality of hardware components and a first plurality of software components usable to implement an artificial intelligence system based on the artificial intelligence architecture map.

16. The non-transitory machine-readable medium of claim 15, wherein obtaining the goal architecture comprises:
performing an optimization process using the plurality of likely use maps and the request to select the first plurality of hardware components and the first plurality of software components.

17. A data processing system, comprising:
a processor; and
a memory coupled to the processor to store instructions, which when executed by the processor, cause the processor to perform operations for managing operation of a distributed system, the operations comprising:
based on a request to update the operation of the distributed system to facilitate provisioning of artificial intelligence-based computer implemented services:
obtaining, based on the request, an artificial intelligence architecture map that defines logical components to provide the artificial intelligence-based computer implemented services;
obtaining a plurality of likely use maps that indicate how the artificial intelligence-based computer implemented services are likely to be used;
obtaining, based on the artificial intelligence architecture map and the plurality of likely use maps, a goal architecture;
selecting, based on at least the goal architecture, a plurality of hardware components and a plurality of software components;
deploying, based on the goal architecture, the plurality of hardware components and the plurality of software components to the distributed system to obtain an updated distributed system; and
providing the artificial intelligence-based computer implemented services using the updated distributed system,
wherein the plurality of likely use maps comprises a data source locations map that indicates first geographic locations of storage devices of the distributed system that are likely to be used to provide the artificial intelligence-based computer implemented services.

18. The data processing system of claim 17, wherein the logical components comprise:
an inference model training module;
an inference generating module;
an inference model updating module;
a training data processing module; and
an inference model distillation module.

19. The data processing system of claim 17, wherein the goal architecture indicates a first plurality of hardware components and a first plurality of software components usable to implement an artificial intelligence system based on the artificial intelligence architecture map.

20. The data processing system of claim 19, wherein obtaining the goal architecture comprises:
performing an optimization process using the plurality of likely use maps and the request to select the first plurality of hardware components and the first plurality of software components.

21. The data processing system of claim 17, wherein the plurality of likely use maps further comprises a use locations map that indicates second geographic locations of likely data processing systems that will use the artificial intelligence-based computer implemented services.
